(19) United States
(12) Patent Application Publication
(10) Pub. No.: US 2022/0232876 A1
(43) Pub. Date: Jul. 28, 2022

(54) COMPOSITION FOR USE IN INDUCING SATIETY

(71) Applicant: FrieslandCampina Nederland B.V., Amersfoort (NL)

(72) Inventors: Jeske Helena Johanna HAGEMAN, Wageningen (NL); Arie Gijsbert NIEUWENHUIZEN, Wageningen (NL); Jaap KEIJER, Wageningen (NL)

(21) Appl. No.: 17/626,447

(22) PCT Filed: Jul. 9, 2020
(86) PCT No.: PCT/EP2020/069320

§ 371 Date: Jan. 11, 2022

(30) Foreign Application Priority Data
Jul. 12, 2019 (EP) 19186038.6

(51) Int. Cl. A23L 33/115; A23L 33/125; A23L 33/17; A23L 2/38; A23L 33/00

(52) U.S. Cl. CPC A23L 33/115; A23L 33/125; A23L 33/40; A23L 2/38; A23L 33/17

(57) ABSTRACT

The invention relates to a method for inducing satiety in a person, said method comprising administering to the person a composition comprising lipid, protein and digestible carbohydrates; wherein the lipid comprises: i. 30 to 90 wt. % vegetable fat, and ii. 10 to 70 wt. % mammalian milk fat, wherein all wt. % are based on total lipid of the composition; characterized in that the lipid is present in the form of lipid globules with the volume % of lipid globules with a diameter below 2 μm is above 60%.

### FIELD OF THE INVENTION

The invention disclosed herein relates to the field of weight management. More in particular, the invention relates to a method for inducing satiety.

### BACKGROUND

Nutritional compositions for infants aim to resemble human milk as much as possible, as human milk is generally seen as the ideal source of nutrition for infants up to at least 6 months of age. Although infant formula have become better and better over time, there are still important differences between human milk and infant formula.

The World Health Organization (WHO) has declared overweight as one of the top ten risk conditions in the world and one of the top five in developed nations (WHO). In most populations, the prevalence of overweight and obesity has steadily increased over the past 20 years (Vasan, R S et al., Estimated risks for developing obesity in the Framingham Heart Study. Ann Intern Med 143:473, 2005). As such, increasing relative weight trends in populations have caused much concern among health care providers (Hill J O et al., Hill J O, Wyatt H R, Reed G W, Peters J C. Obesity and the environment: where do we go from here? Science. 299:853-855, 2003.). Given the growing prevalence of overweight and related health consequences, there is a critical need for affordable and effective weight management strategies.

Obesity is now prevalent even among our youngest children: during 2011-2012, 8.1% of infants and toddlers had weight-for-recumbent-length that was greater than the 95th percentile in the USA (Ogden et al 2014 JAMA Vol 311, Nr 8 pp 806-814). This is particularly alarming because once obesity develops in these early years, it is likely to persist into adulthood, laying the foundation for the continued presence of obesity and related comorbid conditions, such as diabetes and cardiovascular disease, across future generations. Rapid weight gain during the first months of life is an indicator of early childhood obesity (Haire-Joshu et al Annu Rev Public Health. 2016; 37: 253-271; doi: 10.1146/annurev-publhealth-032315-021859).

Diet-induced satiety may be protective against childhood obesity. Gastrointestinal signals are crucial for the regulation of food intake, satiety and satiation. As used herein, “satiation” refers to the end of desire to eat after a meal, and this can occur at any time after the onset of eating. It is governed by hormones and stretch receptors in the stomach. Satiation signals the brain the meal is over. “Satiety,” on the other hand, is a physical feeling of fullness that allows us to stop eating for a while. Ideally, satiety dwindles as nutrients diminish. When nutrients diminish, hunger returns. Satiety feelings on a meal-to-meal basis are to a large extent determined by a coordinated series of neural and humoral signals that originate from the gut in response to mechanical and chemical properties of ingested food (Woods S C; Gastrointestinal satiety signals I. An overview of gastrointestinal signals that influence food intake. Am J Physiol Gastrointest Liver Physiol 286:G7-G13, 2004).

Fat consists of triacylglycerols (TAG) that contain fatty acids esterified at the sn-1, sn-2 and sn-3 position of a glycerol molecule. Human and bovine milk fat contain a wide range of fatty acids, including short-chain fatty acids (SOFA), medium-chain fatty acids (MCFA), and long-chain fatty acids (LCFA), which can either be saturated or unsaturated. Vegetable fat can also contain some MCFA, but does not contain SOFA. While human milk fat, bovine milk fat and vegetable oils such as palm oil are all rich in palmitic acid (C16:0), the distribution of palmitic acid over the glycerol backbone differs among these different lipid sources. In human milk fat most of the palmitic acid is esterified at the sn-2 position of the glycerol molecule.

In general, it is desired that the absorption of nutrients present in a nutritional composition is as effective as possible and the loss of such nutrients via excretion through faeces is as little as possible. At the same time it is also desired that the fat intake is not too high, as this could lead in due time to overweight with associated health problems.

A method for promoting improved eating behavior in an infant has been disclosed in WO2018178310, said method comprising feeding said infant an infant formula or follow on formula comprising lipid, protein and digestible carbohydrates, and wherein the lipid comprises i) 30 to 90 wt. % vegetable lipid based on total lipid, and ii) 10 to 70 wt. % based on total lipid of mammalian milk lipid derived from the group consisting of butter, butter fat, butter oil, and anhydrous milk fat wherein the lipid is in the form of lipid globules, which had a mode diameter, based on volume, of about 5.6 μm, and the volume % of lipid globules with a diameter between 2 and 12 μm was above 45%.

WO2009131436 discloses a satiety enhancing drinking yoghurt having a prolonged shelf life comprising carboxymethyl cellulose. The drinking yoghurt preferably comprises milk fat in an amount of less than about 1 wt %, more preferably in an amount of less than about 0.5 wt %, even more preferably in an amount of less than about 0.1 wt % with respect to the weight of the drinking yoghurt.

Maljaars et al disclose that the effect of lipid droplet size on satiety and peptide secretion is intestinal-site specific, by infusion of a fine or coarse fat emulsion into duodenum or ileum (P. W. Jeroen Maljaars et al 2012 Clinical Nutrition 31 pp 535-542).

It is desired that further compositions be provided that can be used in a method to reduce overweight, e.g. in a method to induce satiety.

It is further desired to provide compositions that can be used in such a method and that are readily acceptable, e.g. that can be combined with a normal diet.

It is an objective of the present invention to provide a composition that better addresses at least one of the aforementioned desires.

### SUMMARY OF THE INVENTION

In one aspect the invention relates to a method for inducing satiety in a person, said method comprising administering to the person a composition comprising lipid, protein and digestible carbohydrates; wherein the lipid comprises i. 30 to 90 wt. % vegetable fat, and ii. 10 to 70 wt. % mammalian milk fat, wherein all wt. % are based on total lipid of the composition, characterized in that the lipid is present in the form of lipid globules with the volume % of lipid globules with a diameter below 2 μm is above 60%. The invention also relates to a weight reduction or weight maintenance program comprising providing a person such a composition. The invention further relates to a non-medical method for inducing satiety in a person comprising administering a person a composition as defined in any of the preceding claims; a composition comprising lipid, protein and digestible carbohydrates; wherein the lipid comprises i. 30 to 90 wt. % vegetable fat, and ii. 10 to 70 wt. % mammalian milk fat, wherein all wt. % are based on total lipid of the composition, characterized in that the lipid is present in the form of lipid globules with the volume % of lipid globules with a diameter below 2 μm is above 60% for use in inducing satiety in a person.

The invention also relates to the use of lipid, protein and digestible carbohydrates; wherein the lipid comprises i. 30 to 90 wt. % vegetable fat, and ii. 10 to 70 wt. % mammalian milk fat, wherein all wt. % are based on total lipid of the composition, characterized in that the lipid is present in the form of lipid globules with the volume % of lipid globules with a diameter below 2 μm is above 60% in the manufacture of a composition for inducing satiety in a person.

### DETAILED DESCRIPTION OF THE INVENTION

The term “treatment”, in relation a given disease or disorder, includes, but is not limited to, inhibiting the disease or disorder, for example, arresting the development of the disease or disorder; relieving the disease or disorder, for example, causing regression of the disease or disorder; or relieving a condition caused by or resulting from the disease or disorder, for example, relieving, preventing or treating symptoms of the disease or disorder.

The term “prevention” in relation to a given disease or disorder means preventing the onset of disease development if none had occurred, preventing the disease or disorder from occurring in a subject that may be predisposed to the disorder or disease but has not yet been diagnosed as having the disorder or disease, and/or preventing further disease/disorder development if already present.

It is also to be understood that this invention is not limited to the specific embodiments and methods described herein, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a”, “an,” and “the” comprise plural referents unless the context clearly indicates otherwise. For example, reference to a component in the singular is intended to comprise a plurality of components.

It will be understood that within this disclosure, any reference to a weight, weight ratio, and the like pertains to the dry matter, in particular the dry matter of the composition.

Unless defined otherwise, all technical and scientific terms used herein generally have the same meaning as commonly understood by one of ordinary skill in the art to which this invention belongs.

As used herein, the term “comprising”, which is synonymous with “including” or “containing”, is open-ended, and does not exclude additional, unrecited element(s), ingredient(s) or method step(s), whereas the term “consisting of” is a closed term, which excludes any additional element, step, or ingredient which is not explicitly recited.

As used herein, the term “essentially consisting of” is a partially open term, which does not exclude additional, unrecited element(s), step(s), or ingredient(s), as long as these additional element(s), step(s) or ingredient(s) do not materially affect the basic and novel properties of the invention.

As used herein, the term “comprising” (or “comprise(s)”) hence includes the term “consisting of” (“consist(s) of”), as well as the term “essentially consisting of” (“essentially consist(s) of”). Accordingly, the term “comprising” (or “comprise(s)”) is, in the present application, meant as more particularly encompassing the term “consisting of” (“consist(s) of”), and the term “essentially consisting of” (“essentially consist(s) of”).

Throughout this application, where publications are referenced, the disclosures of these publications in their entireties are hereby incorporated by reference into this application to more fully describe the state of the art to which this invention pertains.

The term “subject” as used herein refers to a human, that is treatable by the method of the invention. The term “subject” refers to both the male and female sex unless one sex is specifically indicated. The human subject can be an infant 2 years old), a juvenile, an adolescent, an adult or an elderly subject.

The “mode diameter” as used herein, relates to the diameter which is the most present based on volume of total lipid, i.e. the peak value in a graphic representation, having on the X-axis the diameter and on the Y-axis the volume(%). The volume distribution of the particle diameter of the lipid globules is determined using “Laser Diffraction Particle Sizing”, for example using a Malvern Mastersizer apparatus.

In a first aspect, the invention relates to a method for inducing satiety in a person, said method comprising administering to the person a composition comprising lipid, protein and digestible carbohydrates; wherein the lipid comprises

i. 30 to 90 wt. % vegetable fat, and
ii. 10 to 70 wt. % mammalian milk fat,
wherein all wt. % are based on total lipid of the composition,
characterized in that the lipid is present in the form of lipid globules with the volume % of lipid globules with a diameter below 2 μm is above 60%, preferably above 70%, more preferably above 80, most preferably above 90%.

As used herein, “administering a composition to a person” comprises feeding a person such as a child, baby, or infant, it also includes the person eating or drinking the composition. The preferred route of administration is oral administration.

The invention provides a method for inducing satiety, i.e. a method for inducing postprandial events that prolong the feeling of fullness and increase the time for feelings of hunger and prospective consumption to return to pre-prandial levels and thereby regulating meal frequency or meal size, as well as reducing eating or snacking in between meals. This may also be referred to as a method for providing an appetite suppressing effect.

A “prolongation in the feeling of fullness” and/or an “increase of time for feelings of hunger and prospective consumption to return” are defined by comparing satiety feelings in a group of subjects (e.g. 5, preferably at least 10 subjects, more preferably at least 20 subjects) fed a composition as defined in the invention, compared to a group of subjects (of the same age, BMI group and size), fed a placebo composition (similar and isoenergetic and equal in nutrients as defined in the invention that comprises only vegetable fat as lipid source with a mode diameter, based on volume, of between 0.4 μm and 0.5 μm, preferably with a mode diameter of 0.46±0.05 μm.

The present invention can also be referred to as a non-medical method for inducing satiety in a person.

Alternatively, for other jurisdictions, the invention can also be worded as the use of lipid, protein and digestible carbohydrates; wherein the lipid comprises

i. 30 to 90 wt. % vegetable fat, and
ii. 10 to 70 wt. % mammalian milk fat,
wherein all wt. % are based on total lipid of the composition,
characterized in that the lipid is present in the form of lipid globules with the volume % of lipid globules with a diameter below 2 μm is above 60%, preferably above 70%, more preferably above 80, most preferably above 90%, in the manufacture of a composition for inducing satiety in a person.

In other jurisdictions, the invention can also be worded as a composition comprising lipid, protein and digestible carbohydrates; wherein the lipid comprises

i. 30 to 90 wt. % vegetable fat, and
ii. 10 to 70 wt. % mammalian milk fat,
wherein all wt. % are based on total lipid of the composition,
characterized in that the lipid is present in the form of lipid globules with the volume % of lipid globules with a diameter below 2 μm is above 60%, preferably above 70%, more preferably above 80, most preferably above 90% for use in inducing satiety in a person.

The mammalian milk fat as used in the invention refers to milk fat obtained from mammalian milk, preferably from ruminants e.g. milk of sheep, cattle, or goat. More preferably, the mammalian milk fat is milk fat obtained from cattle, even more preferably it is bovine milk fat, most preferably cow's milk fat. The milk fat source can in principle be any available bovine milk fat source, such as whole milk, cream, anhydrous milk fat (AMF) or milk fat fractions resulting from dry fractionation, critical CO₂ extraction or other fractionation methods known in the art. It was, however, found particularly suitable to use whole milk and/or cream as the milk fat source, more preferably to use bovine whole milk and/or cream as the milk fat source.

Alternatively, the mammalian milk fat is selected from the group consisting of bovine butter, bovine butter fat, bovine butter oil.

The fat composition can be prepared by combining the bovine milk fat source(s) with the vegetable lipid source by ways known in the art. Typically, both sources are combined in liquid form, mixed and stored at temperatures at which the blend remains liquid to avoid crystallization and under nitrogen to avoid fat oxidation. Accordingly, the fat composition would typically be stored at 35-50° C. under nitrogen. Alternatively, both sources can be mixed (e.g. when using cream or whole milk), other ingredients may be added, homogenized and spray dried, using methods known in the art. When further processing the fat composition, e.g. into a nutritional composition, the fat composition would be supplied in liquid form as described above and subsequently be processed by combining it with other ingredients.

In one embodiment of the various aspects of the invention, the lipid is present in the form of lipid globules with the volume % of lipid globules with a diameter below 1.0 μm is above 60%, preferably above 70%, more preferably above 80, most preferably 82%. In other embodiments, the lipid globules have a mode diameter, based on volume, of between 0.1 μm and 1.0 μm, preferably of between 0.1 μm and 0.8 μm, more preferably of between 0.1 μm and 0.6 μm, most preferably between 0.3 μm and 0.5 μm. Preferably, the volume % of lipid globules with a diameter below 1.0 μm is above 85% and the lipid globules have a mode diameter, based on volume, of between 0.3 μm and 0.5 μm.

In still another embodiment, the lipid is present in the form of lipid globules with the volume % of lipid globules with a diameter above 0.06 μm is above 60%, preferably above 70%, more preferably above 80, most preferably above 90%. In yet another embodiment, the lipid is present in the form of lipid globules with the volume % of lipid globules with a diameter above 0.10 μm is above 60%, preferably above 70%, more preferably above 80, most preferably above 85%.

In embodiments of the invention the human subject is at least 18 years of age, e.g. at least 25 years, at least 30 years, at least 35 years, at least 40 years, at least 45 years, at least 50 years, at least 55 years, at least 60 years or at least 65 years of age. There is no particular upper limit although in practice, human subjects treated in accordance with the invention will typically be at most 100 years of age, e.g. at most 95 or at most 90 years of age. The composition as used in various aspects of the invention is then selected from one or more of the group consisting of a milk product, a cereal product, a granola product, a nutritional bar, a fortified water, a fruit juice, a fruit smoothie a dairy smoothie, a dairy beverage, an energy drink, a baked good, and a yoghurt.

The composition as used in the different aspects of the invention comprising protein, digestible carbohydrates (typically lactose) and lipid, wherein the lipid source comprises the fat composition as described above, may optionally comprise other ingredients, such as non-digestible oligosaccharides (for example, fructo-oligosaccharides and/or galacto-oligosaccharides) and human milk oligosaccharides (HMO), may be included as well. Such a composition may also be referred to as nutritional composition, is particularly suitable for human subjects of 0 to 36 months of age, in particular infants (a person of 0-12 months of age according to the CODEX Alimentarius (CODEX STAN 72-1981), further referred to as the CODEX) and young children up to the age of 36 months. Nutritional compositions for infants are commonly referred to as infant formula. When used as infant formula, the composition as used in the various aspects of the invention should contain the ingredients in the amounts as prescribed by the CODEX and, if needed, as prescribed by additional regulations of individual countries. An example of an ingredient list of an infant formula meeting the requirements of the EU, China and Codex can for example be found on www.frieslandcampinaingredients.com/ at app/uploads/2019/04/PDS_ELN_EssentialaStart-IF-110.pdf.

Accordingly, in a preferred embodiment, the person i.e. human subject, as referred to in the various aspect of the invention, is an infant (a person of 0-12 months of age) and the composition is an infant the nutritional composition according to the invention for infants comprises the lipid as described above, protein, carbohydrates, vitamins, minerals and trace elements and the other substances in accordance with the specifications prescribed by the CODEX and, if needed, by additional national regulations.

In another embodiment, the person i.e. human subject, as referred to in the various aspect of the invention, is a young child (a person of 12-36 months of age, —also referred to as toddler) and the composition is a ‘follow-up formula for young children’ (FUF-YC)—such a formula may also be referred to as ‘growing up milks’, ‘growing up formulas’ or ‘toddlers’ milk’, or alternatively it may be referred to as “young child formula”. Such a formula comprises the lipid, protein, and digestible carbohydrates as described above, and may further comprise vitamins, minerals and trace elements and the other substances in accordance with the specifications prescribed by the CODEX STANDARD FOR FOLLOW-UP FORMULA (CODEX STAN 156-1987) and, if needed, by additional national regulations.

Accordingly, the composition as used in the various aspects of the invention is selected from one or more of the group consisting of an infant formula, a follow-up formula and young child formula, preferably, the composition is an infant formula or a follow-up formula, more preferably an infant formula.

Human milk oligosaccharides (HMOs) are a key constituent of human milk. They are a structurally and biologically diverse group of complex indigestible carbohydrates. To date, more than 200 different oligosaccharides have been identified, varying in size from 3 to 22 monosaccharide units. The most common HMOs are the neutral fucosylated and non-fucosylated oligosaccharides. The quantity and structure of these HMOs differs significantly among women and is dependent upon Secretor and Lewis blood group status (L. Bode, J. Nutr. 136: 2127-2130, 2006.). In one embodiment, the composition as used in the aspects of the invention comprises one or more HMOs.

The HMOs of human milk are composed of various monosaccharides, namely glucose, galactose, fucose, N-acetylglucosamine and sialic acids (N-acetylneuraminic acid). The sugar fucose is an unusual molecule in that it has the L-configuration, whereas the other sugar molecules in the body have the D-configuration. The structure of HMOs is a lactose unit which may be elongated with one or more galactose and/or N-acetylglucosamine residues (core structure). The HMO core structure may be decorated with one or more fucose residues (i.e. fucosylated HMO) and with one or more sialic acid units (i.e. sialylated HMO). A HMO may also be fucosylated and sialylated. In one embodiment, the HMO in the composition of the invention is selected from one or more the group consisting of core HMO, sialylated HMO, and fucosylated HMO. Nearly 200 HMOs have been identified from human milk. Fucosylated HMOs were found to be the most prominent component (˜77%), while sialylated HMOs accounted for about 16% of the total abundance of HMOs. The fucosylated HMOs are neutral molecules, while the sialylated HMOs are acidic. In human milk, the most abundant HMO is 2′-fucosyllactose (a neutral trisaccharide composed of L-fucose, D-galactose, and D-glucose units, linked Fuc(α1-2)Gal(β1-4)Glc; CAS Nr 41263-94-9), with a concentration of about 2 g/I (Adams et al; 2018, Nutrafoods pp 169-173). Preferred HMOs are 3′-Sialyllactose (3′SL); 6′-Sialyllactose (6′SL); 2′-Fucosyllactose (2′FL); 3-Fucosyllactose (3-FL); lacto-N-tetraose (LNT), lacto-N-neotetraose (LNnT) and disialyllacto-N-tetraose (DSLNT); these are preferred HMOs. Particularly preferred nutritional compositions include at least 2′FL. HMOs can be obtained using methods known to those of skill in the art. For example, HMOs can be purified from human milk. Individual HMOs can be further separated using methods known in the art such as capillary electrophoresis, HPLC (e.g., high-performance anion-exchange chromatography with pulsed amperometric detection; HPAEC-PAD), and thin layer chromatography. See, e.g., U.S. Patent Application No. 2009/0098240. Alternately, enzymatic methods can be used to synthesize HMOs. Another method to manufacture HMO's is via biosynthesis in engineered bacteria. For example, a method of preparing 2′-FL is disclosed in WO 2012/112777. Alternatively, 2′-FL is commercially available e.g. from FrieslandCampina, or others.

In another embodiment of the method according to the invention, the composition comprises 0.25 to 20 wt. % non-digestible oligosaccharides based on dry weight of the composition, preferably wherein the non-digestible oligosaccharides are selected from one or more of galacto-oligosaccharides, and fructo-oligosaccharides, more preferably, wherein the non-digestible oligosaccharides are galacto-oligosaccharides. In other embodiments the minimum amount of non-digestible oligosaccharides is at least 1 wt % based on dry weight of the composition, such as at least 5 wt %. In yet another embodiment, the maximum amount of non-digestible oligosaccharide is 25 wt % based on dry weight of the composition, preferably less than 20 wt %, more preferably less than 15 wt %.

The person (human subject) preferably is aged 0 to 36 months, 0 to 6 months, 6 to 12 months, 6 to 36 months, 12 to 36 months, 12 to 24 months, 2 to 5 years, 5 to 10 years, 10 to 14 years, 14 to 18 years or 18 years and above. More preferably the human subject is aged 0 to 36 months such as 0 to 12 months or 12 to 36 months. Alternatively, the person is aged 18 years and above.

The person (i.e. human subject) preferably has a healthy body weight i.e. a body mass index (BMI) of between 18.5 and below 25.0. BMI is defined as a person's weight in kilograms divided by the square of the person's height in meters (kg/m²). Alternatively, the person has an overweight (BMI between 25 and 30) or is obese (BMI >30). Preferably, the person has a healthy body weight. It is understood that for persons younger than 18 year old, a healthy body weight is defined as a BMI at or above the 5^{th} percentile and below the 85^{th} percentile, overweight is defined as a BMI at or above the 85^{th} percentile and below the 95^{th} percentile for children and teens of the same age and sex. Obesity is defined as a BMI at or above the 95^{th} percentile for children and teens of the same age and sex.

Visual Analogue Score (VAS) is a psychometric response scale which can be used in questionnaires. It is a measurement instrument for subjective characteristics or attitudes that cannot be directly measured. When responding to a VAS item, respondents specify their level of agreement to a statement by indicating a position along a continuous line (10 cm). The position is indicated by placing a line perpendicular to the continuous line. VAS provides robust and reproducible measurements of subjective conditions of the subject in (Raben et al, 1995 Determinants of postprandial appetite sensations: macronutrient intake and glucose metabolism. Int J Obes 1995, 20, 161-169). In one embodiment of the invention, satiety is determined using a visual analogue score (VAS), preferably using a VAS in combination with the questions “How hungry do you feel?”, “How full do you feel?”, “How much could you eat?” and by instructing the subjects to draw a line that best matched how they were feeling on the place of a 10 cm continuous line between end-points “not at all” and “extremely”.

Nearly all human milk fat consists of triacylglycerols (TAG) that contain saturated and unsaturated fatty acids esterified at the sn-1, sn-2 and sn-3 position of a glycerol molecule. While human milk fat, bovine milk fat and vegetable oils such as palm oil are all rich in palmitic acid (C16:0), the distribution of palmitic acid over the glycerol backbone differs among these different lipid sources. In human milk fat most of the palmitic acid is esterified at the sn-2 position of the glycerol molecule. As a consequence, during the digestion of human milk fat less free palmitic acid is released and hence less insoluble calcium and magnesium palmitic acid soaps are formed in the intestine. Similar effects occur for myristic acid (C14:0) and stearic acid (C18:0). Bovine milk fat and especially vegetable oils, on the other hand, have much higher proportions of palmitic acid esterified at the sn-1 and/or sn-3 positions of the glycerol backbone, resulting in release of more free palmitic acid in the digestive process which, in return, leads to formation of more insoluble palmitic acid soaps in the intestine. These insoluble soaps are excreted with the faeces and cause such faeces to be more solid and harder. Accordingly, infants suffer from harder stools leading to complaints such as abdominal pain, gut discomfort and constipation as often expressed by crying. Accordingly, in embodiments of aspects of the invention, the lipid comprises at least 10 wt % palmitic acid based on total fatty acids, such as at least 15 wt %, 20 wt % or even at least 25 wt %, and at least 15 wt % of palmitic acid, based on total palmitic acid, is located at the sn-2 position of a glycerol molecule (glyceride). Preferably, the lipid comprises at least 20 wt % palmitic acid based on total fatty acids and at least 20 wt % of palmitic acid or even at least 25 wt % or even at least 30 wt %, based on total palmitic acid, is located at the sn-2 position of a glycerol molecule. Alternatively, in another embodiment the amount of palmitic acid is 15 to 30 wt. % based on total fatty acids and 25 to 40 wt. % of the palmitic acid is in the sn-2 position in a triglyceride.

A unique feature of milk fat from ruminant animals is the presence of the SOFA butyric acid. SOFA are known to be easily absorbed and transported to the liver for fast oxidation. A limited number of studies examined the effect of oral butyrate supplementation on metabolic disorders. Oral supplementation, but no intravenous administration, of butyrate decreased food intake. Long-term supplementation of butyrate prevented development of obesity and increased insulin sensitivity. This was probably related to an increased fat oxidation and activation of brown adipose tissue (BAT) (Gao et al, 2009 Diabetes 58, 1509-1517) (Li et al, 2018, Gut 67:1269-1279) The presence of butyrate in human milk was negatively associated with infant weight and change in BMI between 3 and 12 months, and BMI at 12 months of age. Prentice et al hypothesized that this might be due to increased thermogenesis by activation of BAT. (Prentice et al, 2019, J Nutr 149:716-722) Butyrate might also have direct effects on vagal afferents, and may induce satiety via this pathway. Bovine milk fat contains from 7.5 to 13.0 mol butyric acid/100 mol FA. Because dibutyrylacylglycerols are present in trace amounts only, this means that about one third of milk fat triacylglycerols contain one molecule of butyrate. Accordingly, in another embodiment of aspects of the invention, at least 10% of the lipid molecules (i.e. triacylglycerols) comprise one molecule of butyrate, preferably at least 15%, more preferably at least 20%, even more preferably at least 25% of the lipid molecules (i.e. triacylglycerols) comprise one molecule of butyrate.

Docosahexaenoic acid (DHA) is an omega-3 fatty acid that is a primary structural component of the human brain, cerebral cortex, skin, and retina. In physiological literature, it is given the name 22:6(n-3). It can be synthesized from alpha-linolenic acid or obtained directly from maternal milk (breast milk), fish oil, or algae oil. DHA is believed to support brain function and eye health. DHA is also for treating type 2 diabetes, coronary artery disease (CAD), dementia, and attention deficit-hyperactivity disorder (ADHD). Hence, in one embodiment of the method according to the invention, the lipid comprises at least 0.1 wt. % docosahexaenoic acid based on total fatty acids, preferably at least 0.2 wt %, more preferably at least 0.4 wt %.

Glycerophospholipids and sphingolipids are quantitatively the most important phospholipids (PLs) in milk. They are located on the milk fat globule membrane (MFGM) and in other membranous material of the skim milk phase. They include principally phosphatidylcholine, phosphatidylethanolamine, phosphatidylinositol and phosphatidylserine, while sphingomyelin is the dominant species of sphingolipids. There is considerable evidence that PLs have beneficial health effects, such as regulation of the inflammatory reactions. So, in another embodiment of the method according to the invention, the lipid comprises at least 5 wt. % sphingomyelin based on total phospholipids, preferably at least 7 wt %, more preferably at least 10 wt %. Optimally, in another embodiment, the lipid globules comprise a coating comprising phospholipid.

The amount of protein in the composition used in the method of the invention, preferably is between 1.8 g to 3.5 g protein/100 kcal in order to meet dietary requirements, preferably between 1.8 g to 2.1 g protein/100 kcal; more preferably, the composition comprises between 1.8 and 2.1 g protein/100 kcal and 4 to 6 g lipid/100 kcal; and 5 to 20 g digestible carbohydrates/100 kcal.

In still another embodiment, the amount of energy in the composition used in the method of the invention, preferably is between 60 to 70 kcal per 100 ml, when the composition is ready to drink. The composition used in methods of the invention may be ready to drink, or may be a dry powder. When in powder form the composition usually is combined with instructions on how to convert the powder in a drinkable formula e.g. by specifying the amount of powder to be dissolved in 100 mL of water.

The method of the invention, for inducing satiety in a human can be combined with a meal replacement, a weight reduction program or a weight maintenance program.

The invention also provides a kit for inducing satiety or suppressing appetite comprising a meal replacement product and a composition as defined for the method of the invention.

The composition as described herein above e.g. in various aspects of the method of the invention may in other aspects be used in a weight reduction or weight maintenance program comprising administering a person a composition as defined elsewhere herein; or alternatively in a non-medical method for inducing satiety in a person comprising administering a person a composition as defined elsewhere herein.

In another aspect the invention relates to a composition comprising lipid, protein and digestible carbohydrates; wherein the lipid comprises i. 30 to 90 wt. % vegetable fat, and ii. 10 to 70 wt. % mammalian milk fat, wherein all wt. % are based on total lipid of the composition, characterized in that the lipid is present in the form of lipid globules with the volume % of lipid globules with a diameter below 2 μm is above 60%, preferably above 70%, more preferably above 80, most preferably above 90% for use in inducing satiety in a person.

In still another aspect the invention relates to the use of lipid, protein and digestible carbohydrates; wherein the lipid comprises i. 30 to 90 wt. % vegetable fat, and ii. 10 to 70 wt. % mammalian milk fat; wherein all wt. % are based on total lipid of the composition, characterized in that the lipid is present in the form of lipid globules with the volume % of lipid globules with a diameter below 2 μm is above 60%, preferably above 70%, more preferably above 80, most preferably above 90% in the manufacture of a composition for inducing satiety in a person.

Some people may have an allergic reaction or sensitivity to carboxymethylcellulose. Accordingly, in one embodiment, the composition as used in the invention is free of carboxymethylcellulose, propylene glycol alginate and/or soy fibre.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies, mutatis mutandis, to normal grammatical variations of the initially defined abbreviation; and, unless expressly stated to the contrary, measurement of a property is determined by the same technique as previously or later referenced for the same property.

The invention is hereinafter illustrated with reference to the following, non-limiting, examples.

### Examples

### Subjects

Twenty healthy Caucasian males, aged 18-28 years with a BMI between 20-25 kg/m² were included in this study. The main baseline characteristics are displayed in Table 1. Males with claustrophobia, (symptoms of) lactose intolerance or cow's milk allergy, known metabolic diseases, autoimmune diseases, gastro-intestinal diseases, cardiovascular diseases were excluded. Smokers or recent smokers, vegetarians, males that consumed more than 21 glasses of alcohol per week, or performed more than 5 hours of strenuous exercise (>6.0 METS) per week, or who donated blood during the two months before the study were excluded. The level of restraint eating was determined with the Dutch eating behavior questionnaire (van Strien et al 1986, The Dutch Eating Behavior Questionnaire (DEBQ) for assessment of restrained, emotional, and external eating behavior. Int J Eat Disord. John Wiley & Sons, Ltd; 1986; 5:295-315), subjects with a score 30 were excluded.

TABLE 1
Baseline subject characteristics (mean ± SD, n = 19).

| | Mean ± SD (n = 19) |
|---|---|
| Age (years) | 21.4 ± 2.0 |
| Body weight (kg) | 75.9 ± 8.3 |
| BMI (kg/m²) | 22.5 ± 1.6 |
| Fat mass (%) | 13.6 ± 2.8 |

### Methods

### Study Design

The study was a double-blind randomized crossover trial involving two days of testing separated by at least one week. On the day preceding a study day, participants were restricted from exercise, alcohol consumption and use of drugs. A standardized dinner containing 584 kcal, 15.0 g fat, 63.9 g carbohydrates, and 43.3 g protein, was provided to the subjects After overnight fasting of 12 hours, subjects were transported by car to the research location. A catheter was placed in the forearm, and participants were asked to lay down on a bed for at least 30 minutes to ensure a resting state. Thereafter, indirect calorimetry was performed using a ventilated hood system (MAX-II Metabolic System, AEI technologies Inc, USA), for determinations of basal energy metabolism. Afterwards, blood samples were taken and a questionnaire with visual analogue scale (VAS) was conducted to determine feelings of hunger, fullness, and prospective consumption. After these baseline measurements, participants consumed one of the two test drinks. Subsequently, participants were placed under the ventilated hood system again and monitored for 5 hours: Every 30 minutes blood samples were taken and satiety feelings were determined using the VAS questionnaire. At 150 minutes postprandial, participants were allowed to drink a glass of water (150 mL) and have a toilet break. During these five hours participants were allowed to watch television, and were instructed to lay as still as possible.

### Test Drinks

Infant Formula (IF) base powders, provided by FrieslandCampina, were used to produce the test drinks. The products were isoenergetic and equal in nutrient composition, see Table 2. The test drinks only differed in fatty acids profile (Table 3). One test drink contained a mixture of vegetable fats only (VEG), the other contained 67% bovine milk fat and 33% of vegetable fats (BOV). The powdered product was diluted in lukewarm water, with a ratio of 1:2.1. To correct for difference in energy expenditure of the participants the total amount of study product to be consumed by participants was based on their total energy expenditure, which was calculated by multiplying the basal metabolic rate with the physical activity level. (TEE). Basal metabolic rate was calculated using the Harris-Benedict equation), based on age, height, and weight. (Harris J A, Benedict F G, 1918 A biometric Study of Human Basal Metabolism. Proc Natl Acad Sci USA, 1918; 4(12):370-373) A physical activity level of 1.75 was used to determine the TEE. The participants received a test drink of which the energy represented 30% of their calculated TEE. Randomization of the treatment was performed with a random sequence generator.

TABLE 2
Nutrient composition of the two test drinks (per 100 gram).

| Composition per 100 gram | VEG * | BOV ** |
|---|---|---|
| Energy (kcal) | 527 | 526 |
| Carbohydrates (g) | 56.1 | 56.1 |
| Fat (g) | 29.0 | 29.0 |
| Of which vegetable fat (g) | 29.0 | 9.5 |
| Of which bovine milk fat (g) | — | 19.5 |
| Protein (Nx6.25) (g) | 10.5 | 10.4 |

* VEG contains a mixture of vegetable fats only
** BOV contains 67% bovine milk fat and 33% of vegetable fats

TABLE 3
Fatty acid composition of the two test drinks (in weight % of total FAMEs).

| Type of fatty acid | VEG * | BOV ** |
|---|---|---|
| C4:0 | <0.1 | 2.6 |
| C6:0 | <0.1 | 1.6 |
| C8:0 | 0.6 | 1.2 |
| C10:0 | 0.5 | 2.1 |
| C11:0 | <0.1 | 0.3 |
| C12:0 | 7.0 | 4.3 |
| C14:0 | 3.0 | 8.2 |
| C15:0 | <0.1 | 0.7 |
| C16:0 | 24.7 | 22.8 |
| C18:0 | 3.1 | 7.1 |
| C18:1 cis-9 | 42.3 | 25.9 |
| C18:2 n-6 | 12.9 | 12.0 |
| C18:3 n-3 | 1.8 | 1.4 |
| Other fatty acid | *** | *** |

* VEG contains a mixture of vegetable fats only
** BOV contains 67% bovine milk fat and 33% of vegetable fats
*** to add up to 100%

### Particle Size Determination

Lipid globule particle size analysis was performed by laser diffraction using a Malvern Hydro LV Mastersizer 3000. Analysis were performed with an obscuration of 10±2. Refractive indexes of 1.33 (water) and 1.47 (vegetable oil) were chosen for the continuous and dispersed phases, respectively. The absorbance was 0.001 and the Mie-model was used for converting the scattering data to size distributions and characteristic diameters. The system was calibrated using polydisperse glass-bead transfer standard.

### Fatty Acid Determination

The content of the different fatty acids in the lipid of the composition of the invention can be determined by standard method ISO 15884/IDF 182:2002 (Milk fat—Preparation of fatty acid methyl esters) and ISO 15885/IDF 184 (Milk fat—Determination of the fatty acid composition by gas-liquid chromatography). These ISO methods allow for determination of molar concentration of a fatty acid relative to total moles of this fatty acid in TAG ([FA-TAG]). The distribution of fatty acids over the glycerol backbone can be determined according to the method disclosed in Luddy, F. E., Barford, R. A., Herb, S. F., Magidman, P. and Riemenschneider, R. W. J. Am. Oil Chem. Soc., 41, 693-696 (1964). In essence, this method involves hydrolysis of triacylglycerols (TAG) by a sn-1,3 specific pancreatic lipase (porcine). The required 2-monoacylglycerols formed are isolated by thin layer chromatography and these are subsequently methylated for gas chromatographic analysis and quantified in molar concentrations relative to the total moles of fatty acids at the sn-2 position ([FA(sn-2)]). The milk fat source can in principle be any available bovine milk fat source, such as whole milk, cream, anhydrous milk fat (AMF) or milk fat fractions resulting from dry fractionation, critical CO₂ extraction or other fractionation methods known in the art. It was, however, found particularly suitable to use whole milk and/or cream as the milk fat source.

### Energy Metabolism

The indirect calorimetry system MAX-II Metabolic System (AEI technologies Inc, USA) was used to determine 02 consumption and CO2 production. Energy expenditure was calculated using the equations of Weir (20). The basal energy expenditure was determined in fasted state, after 30 minutes of rest. By subtracting this basal energy expenditure from the energy expenditure that was measured after consumption of the drinks the diet-induced thermogenesis (DIT) could be calculated.

### VAS Scores

Subjective assessment of hunger, fullness, and prospective consumption was measured on a horizontal 10 cm visual analogue scale (VAS), anchored with “not at all” and “extremely”, right before consumption of the test drinks and every 30 minutes postprandial until five hours after the drink. The specific questions asked were “How hungry do you feel?”, “How full do you feel?”, “How much could you eat?”. Subjects were instructed to draw a vertical line on the place of the line that best matched how they were feeling.

VAS is a psychometric response scale which can be used in questionnaires. It is a measurement instrument for subjective characteristics or attitudes that cannot be directly measured. When responding to a VAS item, respondents specify their level of agreement to a statement by indicating a position along a continuous line (10 cm) between two end-points. The end points used were “not at all” and “extremely”. VAS was used since the subjective measurement represents in a robust and reproducible way the condition of the subject in this respect (Raben et al, 1995 Determinants of postprandial appetite sensations: macronutrient intake and glucose metabolism. Int J Obes 1995, 20, 161-169).

### Statistics

This study had a statistical power of 90% at p=0.05, to detect a difference in Diet-Induced Thermogenesis (DIT) between the two study products of 15 kcal over five hours, with an estimated standard deviation of 20 kcal, when 17 subjects were included. To negate potential dropouts a total of 20 subjects were included.

Averages of DIT were calculated per 30 minutes. Net area under the curve (netAUC) was calculated for DIT, and compared with a Wilcoxon matched-pairs signed rank test. To be able to compare the two products, the VAS scores were corrected for baseline values, and the scores from 30-300 minutes were analyzed with linear regression. Glucose and gastrointestinal peptides were corrected for baseline values, netAUC was calculated, and the two products were compared by a Wilcoxon matched-pairs signed rank test. Spearman correlation analyses were performed for DIT and VAS scores, gastrointestinal peptides and VAS scores, and gastrointestinal peptides and DIT. GraphPad Prism (version 5.04 for Windows, GraphPad Software, San Diego Calif. USA) was used for all statistical analysis. A p-value below 0.05 was considered to be significantly different. One subject was not included in the data analysis due to non-compliance. VAS scores of one participant were excluded due to missing baseline measurements, therefore the VAS scores could not be corrected for baseline values.

### Protein Content

Protein content was determined in accordance with ISO-8968-2, using a multiplication factor of 6.25.

### Results

### Particle Size Distribution of the Test Products

The mode diameter of the test products (VEG and BOV) were 0.36±0.05 μm and 0.46±0.05 μm, respectively. The volume percentages of lipid globules with a diameter below 1 μm was 80% and the volume % of lipid globules with a diameter below 2 μm was 92%.

### Basal Results

The basal energy expenditure and basal VAS scores are presented in Table 4. At baseline, the energy expenditure, and VAS scores did not differ between the two treatment days.

TABLE 4
Baseline values (mean ± SEM, n = 19 for all except for VAS scores; n = 18, compared
with a paired t-test)

| | VEG | BOV | p-value |
|---|---|---|---|
| Basal energy expenditure (kcal) | 2146 ± 60 | 2169 ± 49 | p = 0.54 |
| VAS score ‘hunger’ (cm) | 6.47 ± 0.5 | 6.49 ± 0.4 | p = 0.97 |
| VAS score ‘fullness’ (cm) | 2.48 ± 0.3 | 2.32 ± 0.3 | p = 0.59 |
| VAS score ‘prospective consumption’ (cm) | 6.38 ± 0.4 | 6.66 ± 0.3 | p = 0.35 |

### Diet-Induced Thermogenesis

After consumption of the drinks energy expenditure increased. The netAUC was not different between the two test drinks (VEG vs BOV, respectively 84.7 vs 91.5 kcal, p=0.46).

### Appetite Profile

Feelings of appetite were checked at baseline and every 30 minutes after consumption of the two different drinks. After consumption the initial increase in satiety was similar for both test drinks. And although the slopes for 30-300 minutes of the three different questions to assess satiety were not significantly different for the feeling of fullness and prospective consumption, the intercept was higher after consumption of BOV-test drink, i.e. it takes a longer time period to return to the baseline score after consumption of the BOV-test drink compared to the VEG-test drink (p=0.02 and p=0.001 respectively). After consumption of the VEG-test drink the feeling of prospective consumption had returned to baseline levels at 258 minutes, while after consumption of the BOV-test drink this could be extrapolated to take 321 minutes. For the feeling of fullness this was extrapolated to 333 minutes for the VEG-test drink and 361 minutes for the BOV-test drink. For the feeling of hunger no differences were observed for the intercept after consumption of the two different drinks (p=0.18).

These results show that surprisingly, when compared to the disclosure of the method as described in WO2018178310, a method comprising feeding an infant an infant formula or follow on formula comprising lipid, protein and digestible carbohydrates, and wherein the lipid comprises i) 30 to 90 wt. % vegetable lipid based on total lipid, and ii) 10 to 70 wt. % based on total lipid of mammalian milk lipid derived wherein the lipid is in the form of lipid globules, which had a mode diameter, based on volume, of about 5.6 μm, and the volume % of lipid globules with a diameter between 2 and 12 μm was above 45%; a similar composition comprising lipid, protein and digestible carbohydrates wherein the lipid is present in the form of lipid globules with the volume % of lipid globules with a mode diameter of 0.46 μm, and the volume % of lipid globules with a diameter below 2 μm is above 60% has an effect of inducing satiety.

1. A composition comprising lipid, protein and digestible carbohydrates for inducing satiety in a person, wherein the lipid comprises:
i. 30 to 90 wt. % vegetable fat based on a total lipid of the composition, and
ii. 10 to 70 wt. % mammalian milk fat based on the total lipid of the composition, and
wherein
the lipid is present in the form of lipid globules with a volume % of lipid globules with a diameter below 2 μm being above 60%.

2. The composition for use of claim 1, wherein the lipid is present in the form of lipid globules with the volume % of lipid globules with a diameter below 1.0 μm being above 60%.

3. The composition of claim 1, wherein the lipid globules have a mode diameter, based on volume, of between 0.1 μm and 1.0 μm.

4. The composition of claim 1, wherein the lipid is present in the form of lipid globules with the volume % of lipid globules with a diameter above 0.10 μm being above 60%.

5. The composition of claim 1, wherein the composition is comprises one or more of an infant formula, a follow-up formula and young child formula.

6. The composition of claim 1, wherein the person is aged 0 to 12 months or 12 to 36 months, or wherein the person is aged 18 years and above.

7. The composition of claim 1, wherein the person has a healthy body weight, or the person is overweight, or the person is obese.

8. The composition of claim 1, wherein the lipid comprises at least 10 wt. % palmitic acid based on total fatty acids and at least 15 wt. % of palmitic acid, based on total palmitic acid, is located at the sn-2 position of a glycerol molecule.

9. The composition of claim 1, wherein the lipid comprises at least 0.5 wt. % phospholipid based on total lipid.

10. The composition of claim 1, wherein the lipid globules comprise a coating comprising phospholipid.

11. The composition of claim 1, wherein the composition comprises 0.25 to 20 wt. % non-digestible oligosaccharides based on dry weight of the composition.

12. The composition of claim 1, of wherein the composition further comprises one or more human milk oligosaccharide (HMO).

13. The composition of claim 1, wherein the composition comprises 1.8 to 3.5 g protein/100 kcal, 4 to 6 g lipid/100 kcal, and 5 to 20 g digestible carbohydrates/100 kcal, or wherein the composition, when ready to drink, comprises 60 to 70 kcal per 100 ml.

14. A composition comprising lipid, protein and digestible carbohydrates for use in inducing satiety in a person, wherein the lipid comprises:
i. 30 to 90 wt. % vegetable fat based on a total lipid of the composition, and
ii. 10 to 70 wt. % mammalian milk fat based on a total lipid of the composition,
wherein
the lipid is present in the form of lipid globules with a volume % of lipid globules with a diameter below 2 μm being above 60%.

15. A non-therapeutic method of inducing satiety in a person, the method comprising administering to the person an effective amount of of a composition comprising lipid, protein and digestible carbohydrates.

16. The composition of claim 11, wherein the non-digestible oligosaccharides comprise one or more of galacto-oligosaccharides and fructo-oligosaccharides.

17. The composition of claim 12, wherein the HMO comprises one or more of core HMO, sialylated HMO, and fucosylated HMO.

18. The composition of claim 12, wherein the HMO comprises one or more of 3′-Sialyllactose (3′SL), 6′-Sialyllactose (6′SL), 2′-Fucosyllactose (2′FL), 3-Fucosyllactose (3-FL), lacto-N-tetraose (LNT), lacto-N-neotetraose (LNnT), and disialyllacto-N-tetraose (DSLNT).

19. The method of claim 15, wherein the person is aged 0 to 12 months or 12 to 36 months, or wherein the person is aged 18 years and above.

20. The method of claim 15, wherein the person has a healthy body weight, or the person is overweight, or the person is obese.
